(19) United States
(12) Patent Application Publication
(10) Pub. No.: US 2025/0211683 A1
(43) Pub. Date: Jun. 26, 2025

(54) METHODS AND SYSTEMS FOR NETWORK SLICING CHARGING

(71) Applicant: Apple Inc., Cupertino, CA (US)

(72) Inventors: Xiaoyu Qiao, Beijing (CN); Yuqin Chen, Beijing (CN); Fangli Xu, Beijing (CN); Shu Guo, Beijing (CN); Lanpeng Chen, Beijing (CN); Dawei Zhang, Saratoga, CA (US); Haijing Hu, Los Gatos, CA (US); Huarui Liang, Beijing (CN); Fang Li, Beijing (CN)

(21) Appl. No.: 18/847,597

(22) PCT Filed: Mar. 24, 2022
(86) PCT No.: PCT/CN2022/082774

§ 371 Date: Sep. 16, 2024

(51) Int. Cl. H04M 15/00; H04W 4/24

(52) U.S. Cl. CPC H04M 15/60; H04M 15/51; H04M 15/61; H04W 4/24

(57) ABSTRACT

A network application server including communication circuitry and at least one processor is disclosed. The at least one processor is configured to receive, from a number of user equipments (UEs) and via the communication circuitry, a number of requests to receive service data from a number of application providers; determine an amount of service data exchanged between an application provider and a set of UEs of the number of UEs requesting service data over one or more network slices; generate first billing information corresponding to the application provider based on criteria including the amount of service data exchanged with the application provider over the one or more network slices; and generate second billing information corresponding to each UE of the set of UEs based on data usage by each UE of the set of the UEs, independent of characteristics of the one or more network slices.

### CROSS REFERENCE TO RELATED APPLICATION

This application is a 35 U.S.C. § 371 application of PCT/CN2022/082774, filed on Mar. 24, 2022, and entitled “METHODS AND SYSTEMS FOR NETWORK SLICING CHARGING,” which is incorporated herein by reference as if fully disclosed herein.

### TECHNICAL FIELD

Embodiments described herein generally relate to methods and systems that enable a network provider to charge an application provider.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example environment in which embodiments described herein may be practiced.

FIG. 2 depicts an example network interface diagram for a network in which embodiments described herein may be practiced.

FIG. 3 depicts an example flow diagram showing an exchange of events between various 5G functions, in accordance with some embodiments.

FIG. 4 depicts a flow chart of operations for generating billing information for an application provider and a number of user equipments (UEs), in accordance with some embodiments.

FIG. 5 depicts a flow chart of operations for generating billing information for an application provider, in accordance with some embodiments.

FIG. 6 depicts a flow chart of operations for generating billing information for an application provider, in accordance with some embodiments.

FIG. 7 depicts an example architecture of a wireless communication system of a cellular carrier domain, according to embodiments disclosed herein.

FIG. 8 depicts a system for performing signaling between a UE and a network device, according to embodiments disclosed herein.

### DETAILED DESCRIPTION

Reference will now be made in detail to representative embodiments/aspects illustrated in the accompanying drawings. It should be understood that the following description is not intended to limit the embodiments to one preferred embodiment. On the contrary, it is intended to cover alternatives, modifications, and equivalents as can be included within the spirit and scope of the described embodiments as defined by the appended claims.

Embodiments described herein include methods and systems for generating billing information for an application provider and/or a number of user equipments (UEs) for data exchanged between the UEs and the application provider via a core network and a radio access network (RAN). When a user requests data from an application provider using an application executing on a UE of the number of UEs, the user's request is routed to the application provider based on a UE Route Selection Policy (URSP). The URSP includes a traffic descriptor, which may include an application identifier (AppID). The AppID identifies a particular application the user is using on the UE. Accordingly, when an AppID is used for identifying data exchanged between the application provider and the UE by a network service provider, and for charging the application provider for the data exchanged with the number of UEs over one or more network slices, users' privacy may be at risk.

The network service provider may provide one or more network slices for an application provider to provide application data to the UEs. The network service provider may allocate necessary resources for each network slice based on a service level agreement with a number of users and/or other criteria, including but not limited to, a number of users expected to be requesting data from the application provider, type of data requested by the number of users such as audio, video, and so on, latency, throughput, and so on. The network service provider may then charge the application provider based on services provided using the network slices.

A UE may be assigned a network slice of the one or more network slices allocated by the network service provider for the UE to request service and/or data from an application provider. The UE may request service and/or data from the application provider using the assigned network slice for data exchange with the application provider. The UE may select the network slice based on a URSP rule configured at the UE. As described herein, the URSP rule includes a traffic descriptor, which may be one or more instances of an AppID, an IP 3 tuple as described in 3GPP TS 25.503, a non-IP descriptor, and/or a data network name.

As described herein, in accordance with some embodiments, and by way of a non-limiting example, a network service provider may charge a user of a UE based on granularity of a protocol data unit (PDU) session, a service flow, a quality of service (QOS) flow, and a network service provider may charge an application provider for the one or more network slices that are used for providing services and/or data to a number of UEs based on a total amount of data (e.g., service data) exchanged with the application provider.

In one example, the total amount of data exchanged with the application provider may be measured at an application server of the service provider's core network. As described herein, in accordance with some embodiments, in measuring the total amount of data exchanged between the application provider and a number of UEs, an application used by a UE that is identified in a traffic descriptor by an AppID may not be required.

As described herein, when an AppID is used for charging an application provider for the service and/or data exchanged using one or more network slices provided by a network service provider to the application provider, a user's privacy may be at risk. In addition, selection of a network slice based on an AppID may affect network slice management flexibility. For example, two different applications providing similar types of services may not use the same instance of a network slice, as charging for a specific application per network slice would be difficult. Further, depending on a particular type of data requested by a user and/or based on a geolocation of a user requesting service and/or data from an application provider, the application provider may provide service using different backend services. Further, different versions of an application may provide different capabilities, but may still have the same AppID across all versions of the application, and/or across different platforms or application stores. Accordingly, using an AppID included in a traffic descriptor may not only risk a user's privacy, but may also pose various deployment challenges for charging an application provider based on the AppID.

As described herein, each data packet exchanged between a UE and an application provider may include a network slice identification and an AppID. Accordingly, a network service provider may charge an application provider using the AppID and the network slice identification included in each data packet exchanged using the network service provider's network. However, various embodiments, as described herein, may provide a technological solution for charging an application provider without using an AppID as a mandatory field in a traffic descriptor (and thereby putting a user's privacy at risk). As a result, the AppID may not be needed to appropriately charge an application provider, and may not be needed at all.

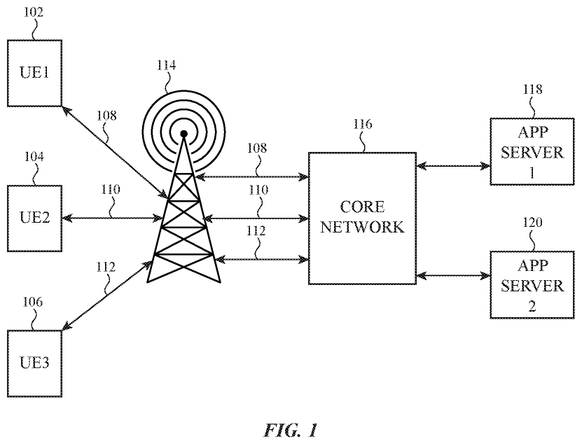

FIG. 1 depicts an example environment in which embodiments described herein may be practiced. As shown in FIG. 1, a number of UEs, for example, a UE1 102, a UE2 104, and a UE3 106 may be communicatively coupled to a network service provider's core network 116 via a base station 114 (e.g., an eNodeB, an eNB, a gNB, an access point (AP)) in a radio access network (RAN) using one or more radio access technologies, such as a 5G, a long term evolution (LTE), and so on. The network service provider may be further communicatively coupled with a number of application servers, such as an App Server 1 118, an App Server 2 120, and so on, of one or more application providers.

In some embodiments, as described herein, the network service provider may allocate one or more network slices based on a service level agreement with the one or more application providers to provide services and/or data from the App Server 1 118 and/or the App Server 2 120 of the one or more application providers to the UE1 102, the UE2 104, and/or the UE3 106. For example, a first network slice 108, a second network slice 110, and a third network slice 112 may be selected by the UE1 102, the UE2 104, and the UE3 106, respectively, for requesting services and/or data from the App Server 1 118 and/or the App Server 2 120 of the one or more application providers. By way of a non-limiting example, in some embodiments, some or all of the UEs may select the same network slice for requesting services and/or data from the App Server 1 118, and some or all of the UEs may select the same network slice for requesting services and/or data from the App Server 2 120, although the network slice(s) selected by the UEs for requesting services and/or data from the App Server 1 118 may differ from the network slice(s) selected by the UEs for requesting services and/or data from the App Server 2 120. And thus, identifiers of the network slices may be used by the network service provider to determine the aggregate amount of data exchanged between an application provider and a set of UEs, without any of the UEs needing to include an AppID traffic descriptor in their requests for services and/or data.

As described herein, each UE of the UE1 102, the UE2 104, and/or the UE3 106 may select and use a particular network slice to send and/or receive data from the one or more application providers. The particular network slice may be selected as per URSP rule configured at each UE, and an identification of a network slice may be included with each message, such as a request, and/or data flowing between the UE and the one or more application providers.

However, as described herein in accordance with some embodiments, a network service provider may generate billing information for one or more application providers without an AppID being included in a traffic descriptor according to an URSP rule. The network service provider may determine a total amount of data exchanged with a particular application provider, for example, at a gateway of the network service provider. Accordingly, the network service provider may not rely upon an AppID included in each packet transmitted between the particular application provider and a UE for generating billing information for the particular application provider; as a result, the UEs no longer need to include the AppID in their packets.

Further, as described herein, in accordance with some embodiments, the network service provider may generate billing information for each UE based on data usage by each UE, and not based on data usage corresponding to an application being used by a user on a UE. An application provider may have a different service level agreement with each user of a UE, and may charge each user of the UE based on the service level agreement.

For example, a first user may have a premium account with an application provider for streaming high-definition (HD) quality videos, and a second user may have a standard account with the application provider for streaming videos based on available network bandwidth. However, as described herein, the network service provider may not be required to consider a different service level agreement (SLA) that each user may have with an application provider. Instead, an application provider may charge a user based on an SLA between the user and the application provider.

In the present disclosure, billing information generation by a network service provider corresponding to an application provider is described using a network slice, but various embodiments, as described herein, may be applied for generating billing information where a network slice is not used to provide service and/or data between a UE and an application provider.

In some embodiments, and by way of a non-limiting example, a network service provider may generate billing information corresponding to an application provider based on an SLA between the network service provider and the application provider. The SLA between the network service provider and the application provider may provide generated billing information based on performance statistics. The performance statistics may be performance statistics of one or more network slices allocated by the network service provider for the application provider to provide services and/or data to a number of UEs. The performance statistics may include, but are not limited to, a total number of online or active users, a total number of connections, a total number of online sessions, latency, and a throughput over a particular time period.

In some embodiments, and by way of a non-limiting example, a service level agreement between a network service provider and an application provider may provide generated billing information based on one or more attributes of one or more network slices allocated by the network service provider. The one or more attributes of the one or more network slices may include, but are not limited to, a peak number of online or active users over a particular time period, a peak number of connections over the particular time period, a peak number of online sessions over the particular time period, and a type of service coverage, such as local, regional, global, and/or a coverage area, and so on.

In some embodiments, and by way of a non-limiting example, a service provider may generate billing information for each UE based on one or more of a number of PDU sessions created and/or active by a UE, a service data flow identifying a particular type of a service or call flow, and a quality of service (QOS) flow identifying a guaranteed QoS, and so on.

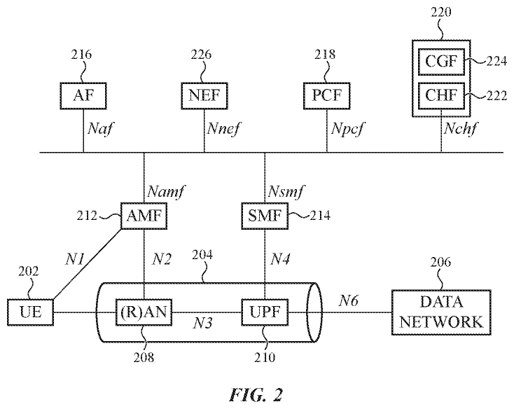

FIG. 2 depicts an example network interface diagram for a network in which embodiments described herein may be practiced. As described herein, a UE 202 receive services and/or data using a network slice 204 from a data network 206 of an application provider. As shown in FIG. 2, the network slice 204 may thus create a pipeline for providing services and/or data communication between the application provider and the UE 202. The network slice 204 may extend through a radio access network (RAN) 208 and a service provider's core network, which may include various functional elements, such as a user plane function (UPF) 210. As shown in FIG. 2, the UPF 210 routes data coming from the UE 202 over the RAN 208 to the application provider's data network 206, and similarly routes data coming from the application provider's data network 206 to the UE 202 over the RAN 208. As shown in FIG. 2, the RAN 208 and the UPF 210 may communicate using a N3 interface and the UPF 210 may communicate with the data network 206 using a N6 interface.

Further, as shown in FIG. 2, the UE 202 and the RAN 208 (e.g., a gNB, eNodeB, an eNB, a base station, and/or an access point) may communicate all connection and session related information with a 5G core access and mobility management function (AMF) 212 using a N1 and a N2 interface, respectively. Accordingly, a connection from the UE 202 to the data network 206 may be established under the control of the AMF 212. A session management function (SMF) 214 may interact with the AMF 212 to establish, modify, and/or release a PDU session through an Nsmf interface and Namf interfaces.

An application provider may set a QoS requirement for the UE 202 based on a service level agreement between the application provider and the UE 202 via a Naf interface with an Application Function (AF) 216 and via an Npcf interface with a Policy Charging Function (PCF) 218. The PCF 218 and the SMF 214 interact with a converged charging system (CCS) 220, which provides a charging function (CHF) 222 for generating charging or billing information, as described herein, in accordance with some embodiments.

In some embodiments, and by way of a non-limiting example, the CCS 220 may include a charging gateway function (CGF) 224, which generates billing records, such as call detail records (CDRs) for transmitting downstream, for example, a user of the UE 202 and/or the application provider.

In some embodiments, the UE 202 may be provided services and/or data from the network service provider and/or the application provider securely via a Network Exposure Function (NEF) 226.

In some embodiments, when the UE 202 requests services and/or data from an application provider, the SMF 214 may select the CHF 222 for generating billing information. The CHF 222 may identify a charging-dedicated network repository function (NRF) for generating billing records and/or CDRs. The SMF 214 may instruct the CHF 222 via an Nchf interface to initiate billing information generation. Accordingly, a billing and operational support system (BOSS) may provide information, such as allowed data usage limits, and so on, to the CHF 222 for generating billing information.

In some embodiments, as described herein, the SMF 214, which manages establishing, modifying, and/or releasing a PDU session for exchanging data with the UE 202, may provide information regarding a service data flow and/or a PDU session for each data packet to the UPF 210.

As shown in FIG. 2, the UPF 210 that is connected to the data network 206 may monitor the total amount of data exchanged with an application provider. The UPF 210 may then report the monitored total amount of exchanged data with the application provider to the SMF 214 via a N4 interface. The SMF 214 may further report the monitored total amount of exchanged data received from the UPF 210 to the CCS 220 and/or CHF 222 for generating billing information for the application provider.

As described herein, the SMF 214 may thus report data usage of a UE separately from a total amount of data exchanged with an application provider. The CHF 222 may generate billing information for the UE 202 based on the data usage reported by the SMF 214 for the UE 202.

As described herein, for generating billing information for an application provider, an AppID is not required in a traffic descriptor to identify the application provider.

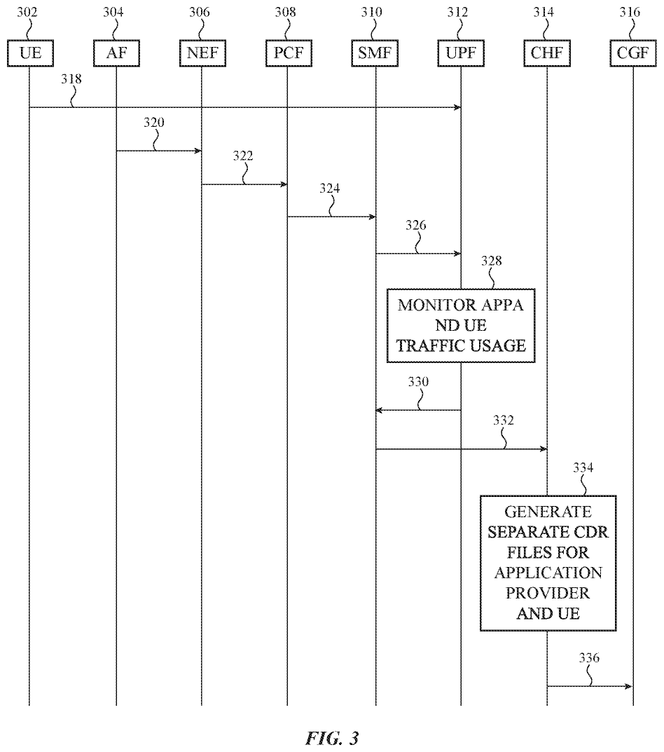

FIG. 3 depicts an example flow diagram showing an exchange of events between various 5G functions, in accordance with some embodiments. As shown in FIG. 3, a PDU session 318 may be established between a UE 302 and a UPF 312 for data transport between the UE 302 and an application provider's data network. The PDU session 318 may be established, as described herein, based on a QoS requirement set by the application provider at an AF 304 and a PCF 308. Further, as described herein, the AF 304 and an SMF 310 establish, modify, and/or release a PDU session, such as the PDU session 318, while an NEF 306 may expose the UE 302 to a service provider's network for receiving services and/or data from one or more application providers.

As shown in FIG. 3, once the PDU session 318 is established, the AF 304 may send information identifying an application 320 being used by the UE 302 for requesting service and/or data from an application provider to the NEF 306, and the NEF 306 may forward the information identifying the application 322 to the PCF 308 using a Nnef interface. The information identifying the application may include, but is not limited to, a data network access identifier (DNAI) which identifies a location where one or more applications are deployed to provide services and/or data to the UE 302 via the PDU session 318.

The PCF 308, upon receiving the DNAI, may instruct the SMF 310 to activate a policy and charging control (PCC) rule 324. The PCC rule provides instructions for handling a particular data packet based on a corresponding application and/or service flow identified using the DNAI. The SMF 310 may then activate a rule 326 at the UPF 312 to identify an amount of data exchanged with a data network of an application provider identified based on the DNAI.

In some embodiments, as described herein, the UPF 312 may monitor traffic from the UE 302 and monitor traffic to an application provider 328 separately. The UPF 312 as a gateway to a data network of one or more application providers may monitor a total amount of data exchanged with each of the one or more application providers. The UPF 312 may report the monitored data usage by the UE 302 and data exchanged with an application provider 330 to the SMF 310. The SMF 310 may then separately report the monitored data usage by the UE 302 and the data exchanged with the application provider 330, as shown in FIG. 3 as 332, to a CHF 314.

In some embodiments, the CHF 314 may then generate billing information for the application provider and the UE 302 based on a total amount of data exchanged with the application provider and as monitored at the UPF 312, and also generate billing information for the UE 302 based on data usage by the UE 302, as described herein, as shown in FIG. 3 as 334. The CHF 314 may then transmit 336 the generated billing information for the application provider and/or the UE 302 as call detail records (CDRs) to a CGF 316 for sending to a user of the UE 302 and/or the application provider.

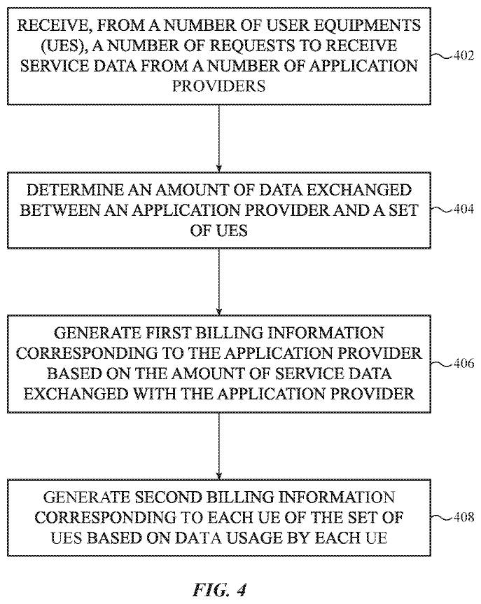

FIG. 4 depicts a flow chart of operations for generating billing information for an application provider and a number of user equipments (UEs), in accordance with some embodiments. Various operations described in FIG. 4 may be performed by a system, such as a service provider's core network system. The system may include at least one server, which may implement various network functions, such as an AF, an NEF, an AMF, an SMF, a PCF, a UPF, a CHF, a CHG, and/or a CCS, and so on, as described herein. The at least one server may include a communication circuitry, which may implement one or more interfaces corresponding to the various network functions described herein.

As shown in FIG. 4, at 402, a number of requests to receive services and/or data from a number of application providers may be received, from a number of user equipments (UEs), at the at least one server via the communication circuitry of the at least one server. As described herein, each request from the number of UEs may include DNAI information, which identifies a data network of the one or more application providers from which services and/or data is requested. Based on each request of the number of requests from the number of UEs, data according to each request may be transmitted over a number of PDU sessions between the number of UEs and the one or more application providers of the number of application providers.

As described herein, an SMF may instruct a UPF to monitor data exchanged with a data network of the one or more application providers and monitor data usage by each UE of the number of UEs. Accordingly, at 404, at least one server, for example, implementing an UPF, may determine an amount of data (e.g., service data) exchanged between an application provider of the number of application providers and a set of UEs of the number of UEs requesting service data from the one or more application providers. As described herein, a network service provider may allocate one or more network slices for the one or more application providers to provide their services and/or data to the number of UEs.

As described herein, a UPF may then report the data exchanged between an application provider of the number of application providers and a set of UEs of the number of UEs requesting service data to an SMF. The SMF may then report the data exchanged between an application provider of the number of application providers and a set of UEs of the number of UEs requesting service data from the application provider separately from data usage by each UE of the set of UEs to a CHF.

At 406, at least one server, for example, implementing a CHF, may generate billing information corresponding to the application provider based on criteria including a total amount of service data exchanged with the application provider over the one or more network slices with the set of UEs of the number of UEs. At 408, the at least one server implementing a CHF may also generate billing information corresponding to each UE of the set of the UEs of the number of UEs based on data usage by each UE of the set of the UEs.

As described herein, billing information for each UE is generated independent of characteristics of the one or more network slices used for providing the requested service data. Thus, billing information for each UE is generated based on their respective data usage, and billing information for an application provider is generated without an AppID included in a traffic descriptor for an URSP rule for a UE.

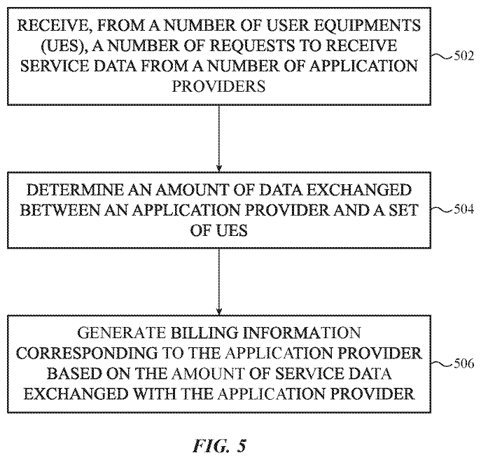

FIG. 5 is a flow chart of operations for generating billing information for an application provider, as described herein, in accordance with some embodiments. Various operations described in FIG. 5 may be performed by a network application server, which, for example, may be located in a network service provider's core network. The network application server may implement various network functions, such as an AF, an NEF, an AMF, an SMF, a PCF, a UPF, a CHF, a CHG, and/or a CCS, and so on, as described herein. The network application server may include a communication circuitry, which may implement one or more interfaces corresponding to the various network functions described herein.

In some embodiments, and by way of a non-limiting example, the network application server, as described herein, may be a single instance of a network application server, or multiple instances of a network application server. Multiple instances of a network application server may be co-located or geographically distributed across many locations, and each instance of a network application server may implement one or more network functions, such as an AF, an NEF, an AMF, an SMF, a PCF, a UPF, a CHF, a CHG, and/or a CCS, and so on, as described herein.

As shown in FIG. 5, at 502, from a number of user equipments (UEs), a number of requests to receive service data from a number of application providers may be received by the network application server. As described herein, each request from the number of UEs may include DNAI information, which identifies a data network of each of the number of application providers from which services and/or data is requested. Based on each request of the number of requests from the number of UEs, requested data may be transmitted over a number of PDU sessions between the number of UEs and the number of application providers.

As described herein, the network application server, as an SMF, may instruct a UPF to monitor data exchanged with a data network of the number of application providers and monitor data usage by each UE of the number of UEs. Accordingly, at 504, the network application, as a UPF, may determine an amount of service data exchanged between an application provider of the number of application providers and a set of UEs of the number of UEs requesting service data over one or more network slices from the application provider.

As described herein, a UPF may then report the data exchanged between an application provider of the number of application providers and a set of UEs of the number of UEs requesting service data to an SMF. The SMF may then report the data exchanged between an application provider of the number of application providers and a set of UEs of the number of UEs requesting service data from the application provider separately from data usage by each UE of the set of UEs to a CHF. By way of a non-limiting example, the SMF and the CHF may be implemented by the network application server.

At 506, the network application server, for example, as a CHF, may generate billing information corresponding to the application provider based on a total amount of service data exchanged with the application provider over the one or more network slices for the set of UEs of the number of UEs. As described herein, for generating the billing information corresponding to the application provider, an application identifier (AppID) is not required to be included in a traffic descriptor associated with a UE Route Selection Policy (URSP) for a UE.

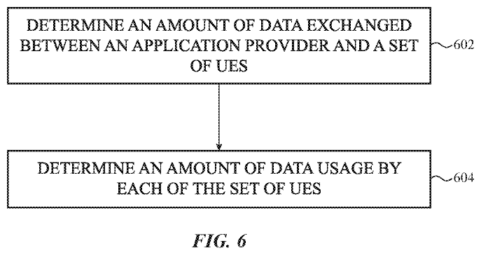

FIG. 6 is a flow chart of operations for generating billing information for an application provider, as described herein, in accordance with some embodiments. Various operations described in FIG. 6 may be performed by a converged charging system, which, for example, may be located in a network service provider's core network. The converged charging system may implement various network functions, such as an AF, an NEF, an AMF, an SMF, a PCF, a UPF, a CHF, a CHG, and/or a CCS, and so on, as described herein. The converged charging system may include a processor, a memory, and communication circuitry for implementing one or more interfaces corresponding to the various network functions and performing the various network functions described herein.

As shown in FIG. 6, at 602, a server of the converged charging system, for example, as a UPF, may determine an amount of service data exchanged between an application provider of a number of application providers and a set of UEs of a number of UEs requesting service data over one or more network slices. At 604, the converged charging system, as a UPF, may determine an amount of data usage by each UE of the set of UEs. As described herein, the UPF may determine the amount of service data exchanged between the application provider and the set of UEs based on one or more rules as received from an SMF.

In some embodiments, another server of the converged charging system, for example, as a CHF, may generate billing information corresponding to the application provider based on criteria including the amount of service data exchanged with the application provider over the one or more network slices for the set of UEs of the number of UEs, and generate billing information corresponding to each UE of the set of the UEs of the number of UEs based on the amount of data usage by each UE of the set of the UEs. As described herein, billing information for each UE is generated independent of characteristics of the one or more network slices used for providing the requested service data to each UE

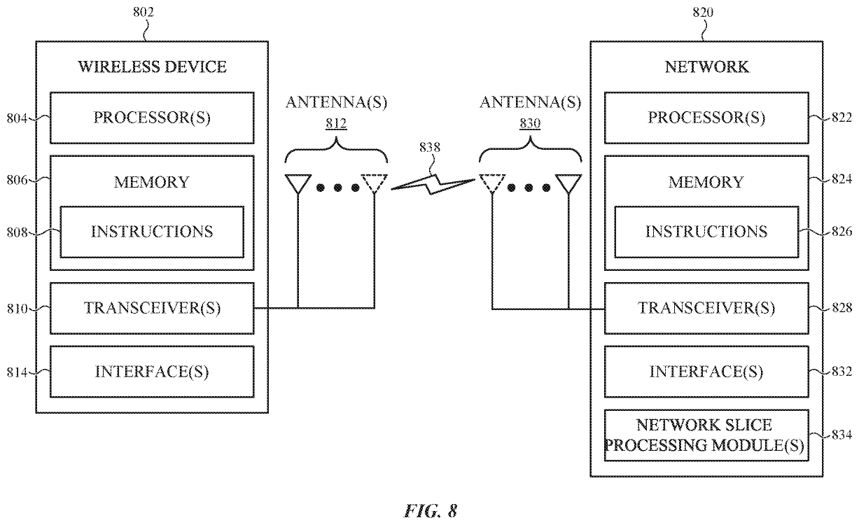

Embodiments contemplated herein include an apparatus having means to perform one or more elements of the method or flow chart shown in FIGS. 3-6. In the context of the method or flow chart shown in FIGS. 3-6, this apparatus may be, for example, an apparatus of a UE (such as a wireless device 802 that is a UE, as described herein), or an application server or a network application server (such as shown in FIG. 8 as 820) implementing one or more network functions, such as an AF, an NEF, an AMF, an SMF, a PCF, a UPF, a CHF, a CHG, and/or a CCS, and so on.

Embodiments contemplated herein include one or more non-transitory computer-readable media storing instructions to cause an electronic device, upon execution of the instructions by one or more processors of the electronic device, to perform one or more elements of the method or flow chart shown in FIGS. 3-6. In the context of the method or flow chart shown in FIGS. 3-6, this non-transitory computer-readable media may be, for example, a memory of a UE (such as a memory 806 of a wireless device 802 that is a UE, as described herein), or a memory of an application server or a network application server (such as a memory 824 of a network device that is an application server of a network application server, as described herein).

Embodiments contemplated herein include an apparatus having logic, modules, or circuitry to perform one or more elements of the method or flow chart shown in FIGS. 3-6. In the context of the method or flow chart shown in FIGS. 3-6, this apparatus may be, for example, an apparatus of a UE (such as a wireless device 802 that is a UE, as described herein), or an application server or a network application server implementing one or more network functions, such as an AF, an NEF, an AMF, an SMF, a PCF, a UPF, a CHF, a CHG, and/or a CCS, and so on (such as a network application server or an application server shown in FIG. 8 as 820).

Embodiments contemplated herein include an apparatus having one or more processors and one or more computer-readable media, using or storing instructions that, when executed by the one or more processors, cause the one or more processors to perform one or more elements of the method or flow chart shown in FIGS. 3-6. In the context of the method or flow chart shown in FIGS. 3-6, this apparatus may be, for example, an apparatus of a UE (such as a wireless device 802 that is a UE, as described herein), or an application server or a network application server implementing one or more network functions, such as an AF, an NEF, an AMF, an SMF, a PCF, a UPF, a CHF, a CHG, and/or a CCS, and so on (such as a network application server or an application server shown in FIG. 8 as 820).

Embodiments contemplated herein include a signal as described in or related to one or more elements of the method or flow chart shown in FIGS. 3-6.

Embodiments contemplated herein include a computer program or computer program product having instructions, wherein execution of the program by a processor causes the processor to carry out one or more elements of the method or flow chart shown in FIGS. 3-6. In the context of the method or flow chart shown in FIGS. 3-6, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein, or on a memory of the application server or the network application server implementing one or more network functions, such as an AF, an NEF, an AMF, an SMF, a PCF, a UPF, a CHF, a CHG, and/or a CCS, and so on (such as a memory 824 of an application server or a network application server shown in FIG. 8 as 820).

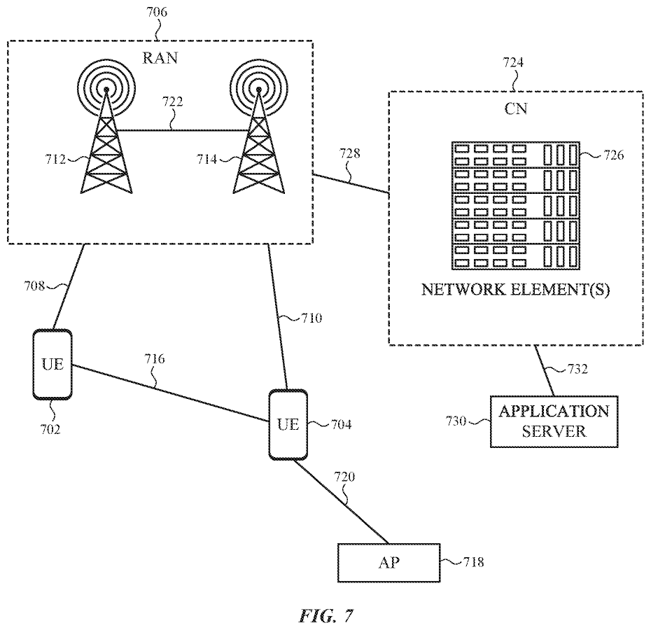

FIG. 7 depicts an example architecture of a wireless communication system of a cellular carrier domain, according to embodiments disclosed herein. The following description is provided for an example wireless communication system that operates in conjunction with the LTE system standards and/or 5G or NR system standards, and/or future standards for 6G, and so on, as provided by 3GPP technical specifications.

As shown by FIG. 7, the wireless communication system includes a UE 702 and a UE 704 (although any number of UEs may be used). In this example, the UE 702 and the UE 704 are illustrated as smartphones (e.g., handheld touchscreen mobile computing devices connectable to one or more cellular networks) but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling and may be consistent with one or more radio access technologies (RATs) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

FIG. 8 depicts a system for performing signaling between a UE and a network device, according to embodiments disclosed herein. A system shown in FIG. 8 may be a portion of a wireless communication system as herein described. The wireless device 802 may be, for example, a UE of a wireless communication system. The network 820 may include, for example, a base station or an access point in radio access network connected to a wireless communication system via wired or wireless communication links, and one or more application servers or network servers located in core network.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments, the wireless device 802 (e.g., a UE) may communicate with the network 820 (e.g., a base station or an access point, and/or one or more application servers or network application servers). The wireless device 802 may communicate with the access point via the antennas 812, and the access point may communicate with the network 820 via a wired or wireless connection.

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The base station, application server, and/or network application server shown in FIG. 8 as 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The base station, application server, and/or network application server shown in FIG. 8 as 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The base station, application server, and/or network application server shown in FIG. 8 as 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs. In certain embodiments, the signaling 838 may occur via a wired or a wireless network.

The base station, application server, and/or network application server shown in FIG. 8 as 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The base station, application server, and/or network application server shown in FIG. 8 as 820 may include one or more interface(s) 832. The interface(s) 832 may be used to provide input to or output from the network device 820. For example, a network 820 that is a base station may include interface(s) 832 made up of transmitters, receivers, and other circuitry (e.g., other than the transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

The base station, application server, and/or network application server shown in FIG. 8 as 820 may include a network slice processing module 834 configured to perform various embodiments for charging an application provider, as described herein. The network slice processing module 834 may be implemented via hardware, software, or combinations thereof. For example, the network slice processing module 834 may be implemented as a processor, circuit, and/or instructions 826 stored in the memory 824 and executed by the processor(s) 822. In some examples, the network slice processing module 834 may be integrated within the processor(s) 822. For example, the network slice processing module 834 may be implemented by a combination of software components (e.g., executed by a DSP or a general processor) and hardware components (e.g., logic gates and circuitry) within the processor(s) 822.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

What is claimed is:

1. A network application server, comprising:
communication circuitry; and
at least one processor configured to:
receive, from a number of user equipments (UEs) and via the communication circuitry, a number of requests to receive service data from a number of application providers;
determine an amount of service data exchanged between an application provider of the number of application providers and a set of UEs of the number of UEs requesting service data over one or more network slices;
generate first billing information corresponding to the application provider based on criteria including the amount of service data exchanged with the application provider over the one or more network slices for the set of UEs; and
generate second billing information corresponding to each UE of the set of UEs based on data usage by each UE of the set of UEs, the second billing information generated independent of characteristics of the one or more network slices used for providing the requested service data.

2. The network application server of claim 1, wherein the criteria for generating the first billing information corresponding to the application provider further includes at least one of:
performance statistics of the one or more network slices; or
one or more attributes of the one or more network slices.

3. The network application server of claim 2, wherein the performance statistics of the one or more network slices include at least one of:
a total number of online or active users;
a total number of connections;
a total number of online sessions;
latency; or
a throughput over a particular time period.

4. The network application server of claim 2, wherein the one or more attributes of the one or more network slices include at least one of:
a peak number of online or active users over a particular time period;
a peak number of connections over the particular time period;
a peak number of online sessions over the particular time period; or
a type of service coverage.

5. The network application server of claim 1, wherein each UE of the set of UEs is further charged based on one or more of:
a number of protocol data unit (PDU) sessions;
a service data flow; or
a quality of service (QOS) flow.

6. The network application server of claim 1, wherein the amount of service data exchanged with the application provider over the one or more network slices for the set of UEs is determined without an application identifier (AppID) associated with a UE Route Selection Policy (URSP) for each UE of the set of UEs.

7. The network application server of claim 1, wherein each network slice of the one or more network slices is configured to provide the requested service data according to a different quality of service or a service level agreement with a UE of the set of UEs.

8. A method, comprising:
receiving, from a number of user equipments (UEs) at a network application server, a number of requests to receive service data from a number of application providers;
determining, by the network application server, an amount of service data exchanged between an application provider of the number of application providers and a set of UEs of the number of UEs requesting service data over one or more network slices; and
generating, by the network application server, billing information corresponding to the application provider based on a total amount of service data exchanged with the application provider over the one or more network slices for the set of UEs, without identifying the application provider using an application identifier (AppID) associated with a UE Route Selection Policy (URSP) for each UE of the set of UEs of the number of UEs.

9. The method of claim 8, wherein the billing information is first billing information, the method further comprising:
generating second billing information corresponding to each UE of the set of UEs based on data usage by each UE of the set of UEs, the second billing information generated independent of characteristics of the one or more network slices used for providing the requested service data.

10. The method of claim 8, further comprising generating the billing information corresponding to the application provider based on performance statistics of the one or more network slices.

11. The method of claim 10, wherein the performance statistics of the one or more network slices include at least one of:
a total number of online or active users;
a total number of connections;
a total number of online sessions;
latency; or
a throughput over a particular time period.

12. The method of claim 8, further comprising generating the billing information corresponding to the application provider based on one or more attributes of the one or more network slices.

13. The method of claim 12, wherein the one or more attributes of the one or more network slices include at least one of:
a peak number of online or active users over a particular time period;
a peak number of connections over the particular time period;
a peak number of online sessions over the particular time period; or
a type of service coverage.

14. The method of claim 8, wherein the billing information is first billing information, the method further comprising:
generating the second billing information corresponding to each UE of the set of UEs based on one or more of:
a number of protocol data unit (PDU) sessions;
a service data flow; or
a quality of service (QOS) flow.

15. The method of claim 8, wherein each network slice of the one or more network slices is configured to provide the requested service data according to a different quality of service or a service level agreement with a UE of the set of UEs.

16. A converged charging system (CCS), comprising:
a first server comprising:
a first processor; and
a first memory storing instructions, which when executed by the first processor cause the first server to perform the operations of:
determining an amount of service data exchanged between an application provider of a number of application providers and a set of UEs of a number of UEs requesting service data over one or more network slices; and
determining an amount of data usage by each UE of the set of UEs.

17. The CCS of claim 16, further comprising:
a second server comprising:
a second processor; and
a second memory storing instructions, which when executed by the second processor cause the second server to perform the operations of:
generating first billing information corresponding to the application provider based on criteria including the amount of service data exchanged with the application provider over the one or more network slices for the set of UEs; and
generating second billing information corresponding to each UE of the set of UEs based on the amount of data usage by each UE of the set of UEs, the second billing information generated independent of characteristics of the one or more network slices used for providing the requested service data.

18. The CCS of claim 17, wherein generating the first billing information corresponding to the application provider comprises generating the first billing information corresponding to the application provider without identifying the application provider using an application identifier (AppID) associated with a UE Route Selection Policy (URSP) for each UE of the set of UEs.

19. The CCS of claim 17, wherein the criteria for generating the first billing information corresponding to the application provider further includes at least one of:
performance statistics of the one or more network slices; or
one or more attributes of the one or more network slices.

20. The CCS of claim 19, wherein:
the performance statistics of the one or more network slices include at least one of a total number of online or active users, a total number of connections, a total number of online sessions, latency, or a throughput over a particular time period; and
the one or more attributes of the one or more network slices include at least one of a peak number of online or active users over a particular time period, a peak number of connections over the particular time period, a peak number of online sessions over the particular time period, or a type of service coverage.
